(19) United States
(12) Patent Application Publication
(10) Pub. No.: US 2009/0066876 A1
(43) Pub. Date: Mar. 12, 2009

(54) PHOTOSENSOR CIRCUIT, LIQUID CRYSTAL DISPLAY HAVING THE SAME AND METHOD OF DRIVING THE LIQUID CRYSTAL DISPLAY

(75) Inventors: Doo-Hyung WOO, Anyang-si (KR); Jae-Beom CHOI, Suwon-si (KR); Kwang-Sub SHIN, Seoul (KR); Chul-Ho KIM, Yongin-si (KR); Young-Il KIM, Suwon-si (KR); Yang-Hwa CHOI, Yongin-si (KR)

Correspondence Address: CANTOR COLBURN, LLP, 20 Church Street, 22nd Floor, Hartford, CT, 06103, US

(73) Assignee: Samsung Electronics Co., Ltd., Suwon-si (KR)

(21) Appl. No.: 12/166,370

(22) Filed: Jul. 2, 2008

(30) Foreign Application Priority Data
Sep. 7, 2007 (KR) 10-2007-0091145

(51) Int. Cl. G02F 1/1335; G01J 1/32

(52) U.S. Cl. 349/61; 250/205

(57) ABSTRACT

A photosensor circuit includes a read-out circuit and a determiner. The read-out circuit includes: a first photosensor which outputs a first reference current corresponding to an intensity of a first reference light; a second photosensor which outputs a second reference current corresponding to an intensity of a second reference light; a third photosensor which outputs an external light current corresponding to an intensity of an external light; a first current memory which senses the first reference current; a second current memory which senses a difference between the first and second reference currents; and a storage capacitor which charges during a first period of time and discharges during a second period of time. The determiner calculates the intensity of the external light based on the intensities of the first and second reference lights and durations of the first and second periods of time.

This application claims priority to Korean Patent Application No. 10-2007-0091145, filed on Sep. 7, 2007, and all the benefits accruing therefrom under 35 U.S.C. §119, the contents of which in its entirety are herein incorporated by reference.

### BACKGROUND OF THE INVENTION

1. Field of the Invention

The present invention relates to a photosensor circuit, a liquid crystal display (“LCD”) having the same and a method of driving the LCD. More particularly, the present invention relates to a photosensor circuit which accurately measures an intensity of external light in real time, an LCD including the photosensor circuit and a method of driving the LCD.

2. Description of the Related Art

A conventional liquid crystal display (“LCD”) includes a liquid crystal panel. The liquid crystal panel has a first display substrate having a pixel electrode, a second display substrate having a common electrode and a dielectrically anisotropic liquid crystal layer injected between the first display substrate and the second display substrate.

The LCD displays a desired image by forming an electric field between the pixel electrode and the common electrode and adjusting an intensity of the electric field to control an amount of light transmitted through the liquid crystal panel. Since the LCD is not a self light-emitting display, the LCD typically includes a backlight unit, which functions as a light source, disposed on a rear surface of the liquid crystal panel.

In the LCD having the backlight unit, power consumption of the backlight unit constitutes a considerable portion of total power consumption of the LCD. In a mobile thin film transistor (“TFT”) LCD, for example, power consumption of the backlight unit is approximately 80% of total power consumption of TFT LCD. To reduce power consumption of the backlight unit, a method of controlling a luminance of the backlight unit based on an intensity of external illumination is being developed.

In the method, an optical sensor which measures the intensity of the external illumination, such as a pin diode, is built into the liquid crystal panel of the LCD using a polysilicon TFT process. However, optical sensors, e.g., pin diodes, exhibit different optical characteristics according to liquid crystal panels that the optical sensors are built in. As a result, each manufactured panel has an optical sensor having different optical characteristics from other manufactured panels. The optical characteristics of each optical sensor for each panel may be measured in advance to correct for the different optical characteristics of the optical sensor for each panel, but this increases production costs of the LCD, reducing a production efficiency thereof However, if the different optical characteristics of the optical sensor for each panel are not corrected, each optical sensor cannot accurately measure the intensity of the external light, and a resolution of the optical sensor thereby deteriorates.

### BRIEF SUMMARY OF THE INVENTION

A photosensor according to an exemplary embodiment of the present invention included a read-out circuit and a determiner. The read-out circuit includes a first photosensor which outputs a first reference current corresponding to an intensity of a first reference light; a second photosensor which outputs a second reference current corresponding to an intensity of a second reference light; a third photosensor which outputs an external light current corresponding to an intensity of an external light; a first current memory which senses and reproduces the first reference current; a second current memory which senses and reproduces a difference between the second reference current and the first reference current; and a storage capacitor which charges during a first period of time based on the difference between the second reference current and the first reference current, and which discharges during a second period of time based on a difference between the external light current and the first reference current.

The determiner calculates the intensity of the external light based on the intensity of the first reference light, the intensity of the second reference light, a duration of the first period of time and a duration of the second period of time.

A liquid crystal display (“LCD”) according to an alternative exemplary embodiment of the present invention includes a liquid crystal panel which displays an image; a photosensor circuit which measures an intensity of external light and includes a read-out circuit and a determiner; and a backlight unit which provides backlight to the liquid crystal panel.

The read-out circuit includes a first photosensor which outputs a first reference current corresponding to an intensity of a first reference light; a second photosensor which outputs a second reference current corresponding to an intensity of a second reference light; a third photosensor which outputs an external light current corresponding to the intensity of the external light; a first current memory which senses and reproduces the first reference current; a second current memory which senses and reproduces a difference between the second reference current and the first reference current; and a storage capacitor which charges during a first period of time based on the difference between the second reference current and the first reference current, and which discharges during a second period of time based on a difference between the external light current and the first reference current.

The determiner calculates the intensity of the external light based on the intensity of the first reference light, the intensity of the second reference light, a duration of the first period of time and a duration of the second period of time.

A luminance of the backlight is controlled according to the calculated intensity of the external light

According to another exemplary embodiment of the present invention, a method of driving an LCD method includes: generating a first reference current, corresponding to an intensity of a first reference light, and sensing the first reference current in a first part of a first section of an operation; reproducing the sensed first reference current in a second part of the first section of the operation; outputting the second reference current and sensing a difference between the first reference current and the second reference current in a first part of a second section of the operation; reproducing the sensed difference between the first reference current and the second reference current in a second part of the second section of the operation; receiving the reproduced sensed difference between the first reference current and the second reference current for a first period of time in a third section of the operation; outputting a difference between an external light current corresponding to an intensity of an external light and the first reference current for a second period of time in a fourth section of the operation; calculating the intensity of the external light using the intensity of the first reference light, the intensity of the second reference light, a duration of the first period of time and a duration of the second period of time; controlling a luminance of backlight according to the calculated intensity of the external light; receiving the backlight having the controlled luminance; and displaying a desired image with the backlight.

### BRIEF DESCRIPTION OF THE DRAWINGS

The above and other aspects, features and advantages of the present invention will become more readily apparent by describing in further detail exemplary embodiments thereof with reference to the accompanying drawings, in which:

FIG. 1A is a block diagram of a liquid crystal display (“LCD”) according to an exemplary embodiment of the present invention;

FIG. 1B is a block diagram of a photosensor circuit of the LCD according to the exemplary embodiment of the present invention shown in FIG. 1A;

FIG. 2 is a schematic circuit diagram of a read-out circuit of a photosensor circuit according to an exemplary embodiment of the present invention;

FIG. 3 is a signal timing diagram of the read-out circuit of the photosensor circuit according to the exemplary embodiment of the present invention shown in FIG. 2 and a corresponding graph of voltage versus time illustrating a variation of a voltage in a storage capacitor of the read-out circuit of the photosensor circuit according to the exemplary embodiment of the present invention shown in FIG. 2;

FIGS. 4A through 4H are schematic circuit diagrams illustrating different operational states of the read-out circuit according to the exemplary embodiment of the present invention shown in FIG. 2;

FIG. 5 is a block diagram of a photosensor circuit according to an alternative exemplary embodiment of the present invention;

FIG. 6 is a plan view of an LCD according to an exemplary embodiment of the present invention; and

FIG. 7 is a partial cross-sectional view taken along line V-V′ of the LCD according to the exemplary embodiment of the present invention shown in FIG. 6.

### DETAILED DESCRIPTION OF THE INVENTION

The invention will now be described more fully hereinafter with reference to the accompanying drawings, in which exemplary embodiments of the invention are shown. The present invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including,” when used in this specification, specify the presence of stated features, regions, integers, steps, operations, elements and/or components, but do not preclude the presence or addition of one or more other features, regions, integers, steps, operations, elements, components and/or groups thereof

Furthermore, relative terms, such as “lower” or “bottom” and “upper” or “top” may be used herein to describe one element's relationship to other elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on the “upper” side of the other elements. The exemplary term “lower” can, therefore, encompass both an orientation of “lower” and “upper,” depending upon the particular orientation of the figure. Similarly, if the device in one of the figures were turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning which is consistent with their meaning in the context of the relevant art and the present disclosure, and will not be interpreted in an idealized or overly formal sense unless expressly so defined herein.

Exemplary embodiments of the present invention are described herein with reference to cross section illustrations which are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes which result, for example, from manufacturing. For example, a region illustrated or described as flat may, typically, have rough and/or nonlinear features. Moreover, sharp angles which are illustrated may be rounded. Thus, the regions illustrated in the figures are schematic in nature and their shapes are not intended to illustrate the precise shape of a region and are not intended to limit the scope of the present invention.

Hereinafter, exemplary embodiments of the present invention will be explained in further detail with reference to the accompanying drawings.

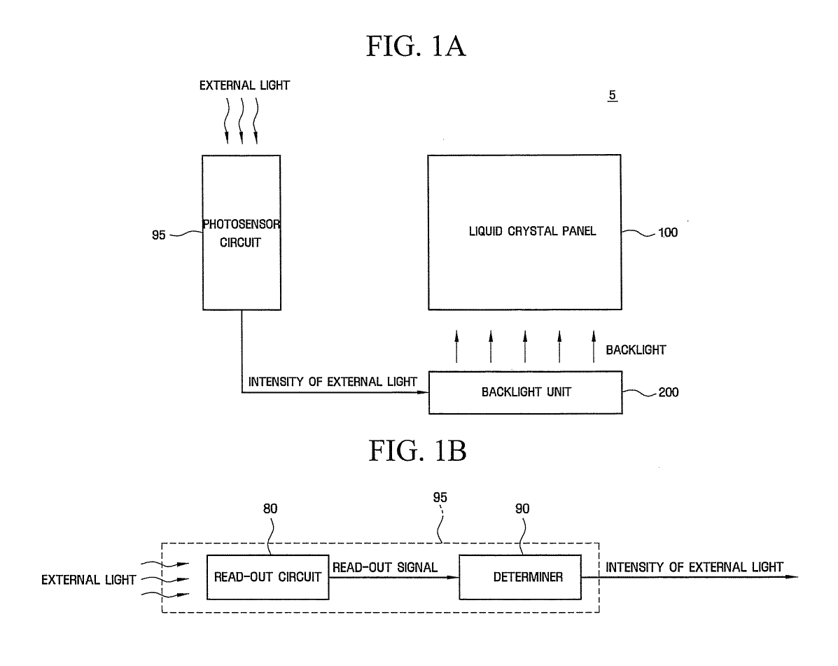

A liquid crystal display (“LCD”) having a photosensor circuit according to an exemplary embodiment of the present invention will now be described in further detail with reference to FIGS. 1A and 1B. FIG. 1A is a block diagram of an LCD according to an exemplary embodiment of the present invention, and FIG. 1B is a block diagram of a photosensor circuit of the LCD according to the exemplary embodiment of the present invention shown in FIG. 1A.

Referring to FIGS. 1A, an LCD 5 according to an exemplary embodiment of the present invention includes a liquid crystal panel 100, a photosensor circuit 95 and a backlight unit 200. The liquid crystal panel 100 displays a desired image using backlight supplied from the backlight unit 200. The photosensor circuit 95 measures an intensity of external light and transmits a signal proportional to the measured intensity of the external light to the backlight unit 200.

Referring to FIG. 1B, the photosensor circuit 95 includes a read-out circuit 80, which receives the external light and outputs a read-out signal to a determiner 90. The determiner 90 receives the read-out signal and calculates the signal proportional to the intensity of the external light which is transmitted to the backlight unit 200 (FIG. 1A).

The backlight unit 200 is installed on a rear surface of the liquid crystal panel 100 and supplies the backlight to the liquid crystal panel 100 to display the desired image. A luminance of the backlight is controlled based on the signal proportional to the intensity of external light calculated by the photosensor circuit 95.

In the LCD including the photosensor circuit 95 according to an exemplary embodiment of the present invention, the photosensor circuit 95 accurately measures the intensity of the external light in real time, and the luminance of backlight is thereby properly controlled based on the measured intensity of the external light.

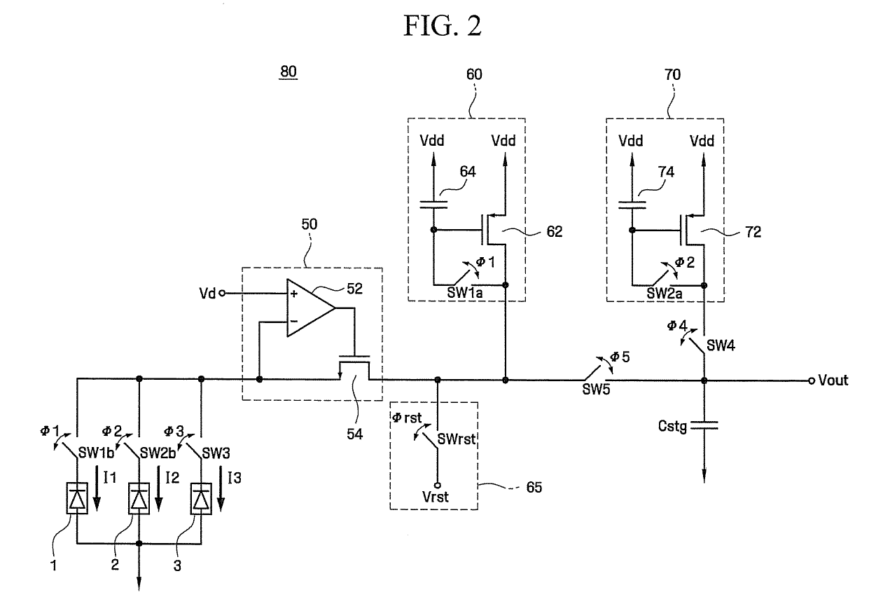

The read-out circuit 80 of the photosensor circuit 95 according to an exemplary embodiment of the present invention will now be described in further detail with reference to FIG. 2. FIG. 2 is a schematic circuit diagram of a read-out circuit 80 of a photosensor circuit according to an exemplary embodiment of the present invention.

Referring to FIG. 2, the read-out circuit 80 of the photosensor circuit 95 according to an exemplary embodiment includes a first photosensor 1, a second photosensor 2, a third photosensor 3, a first current memory 60, a second current memory 70 and a storage capacitor Cstg.

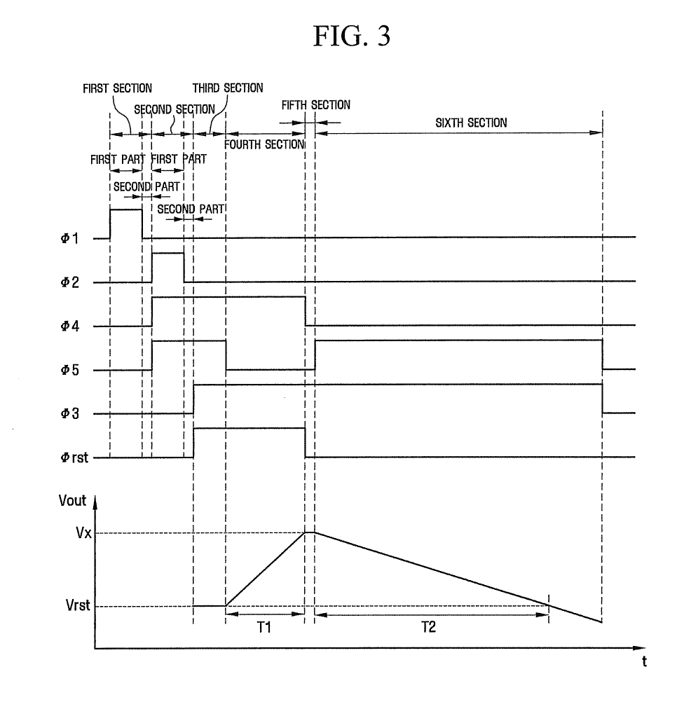

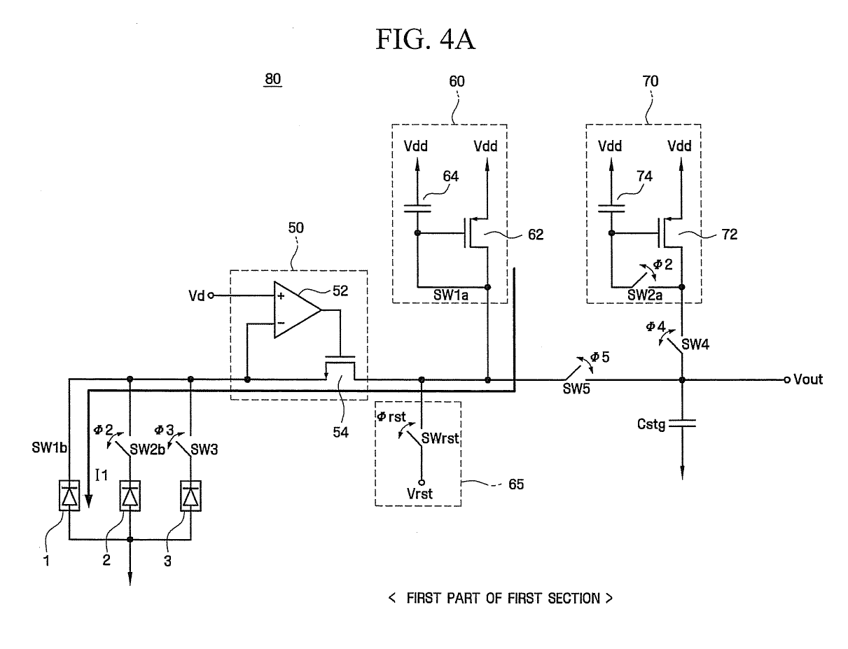

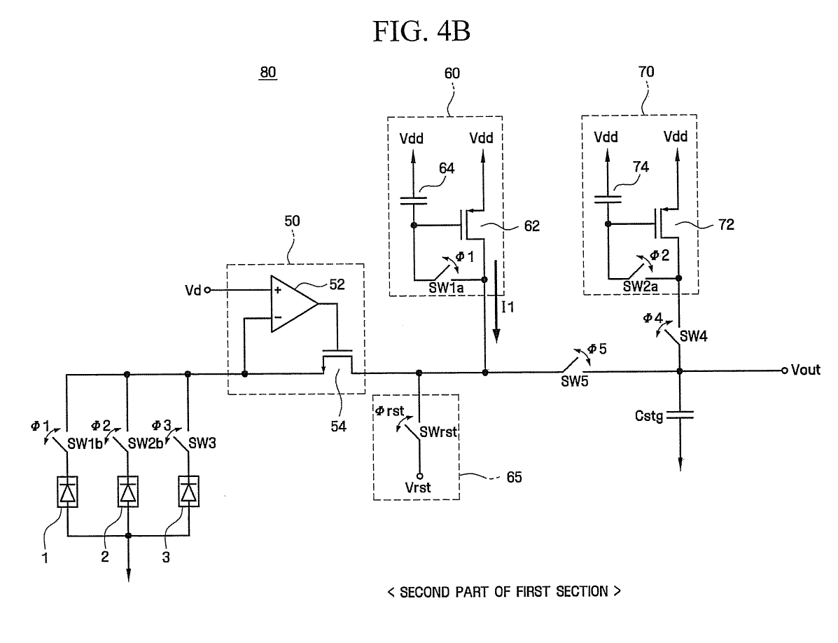

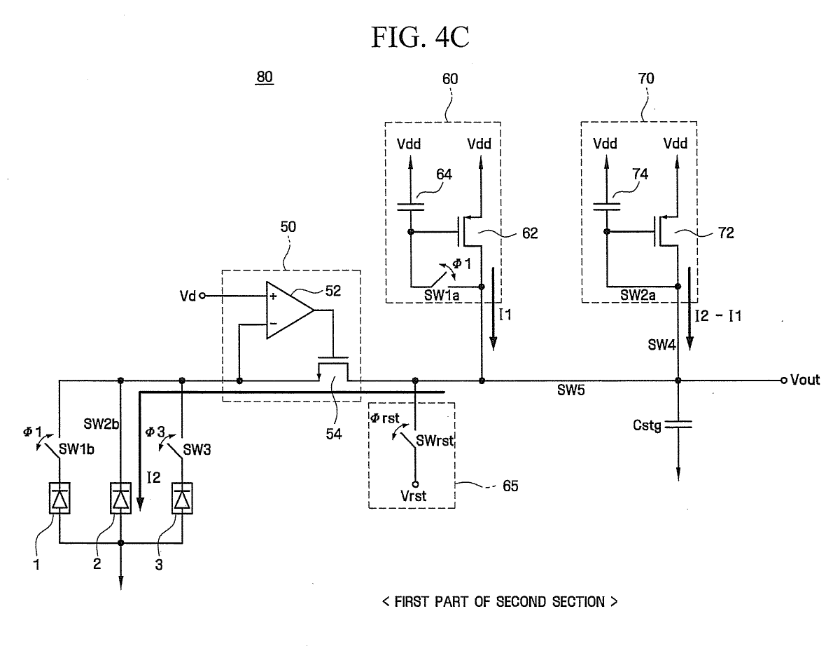

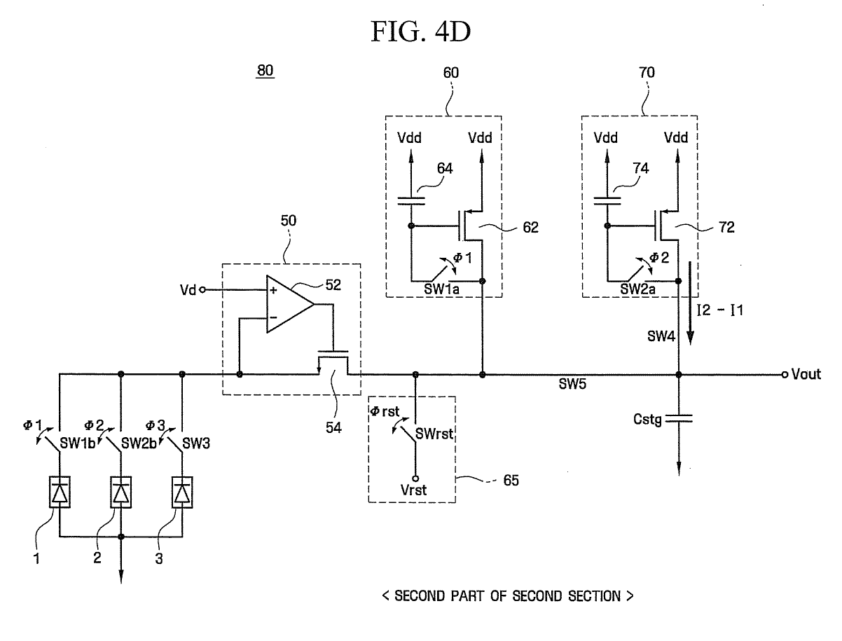

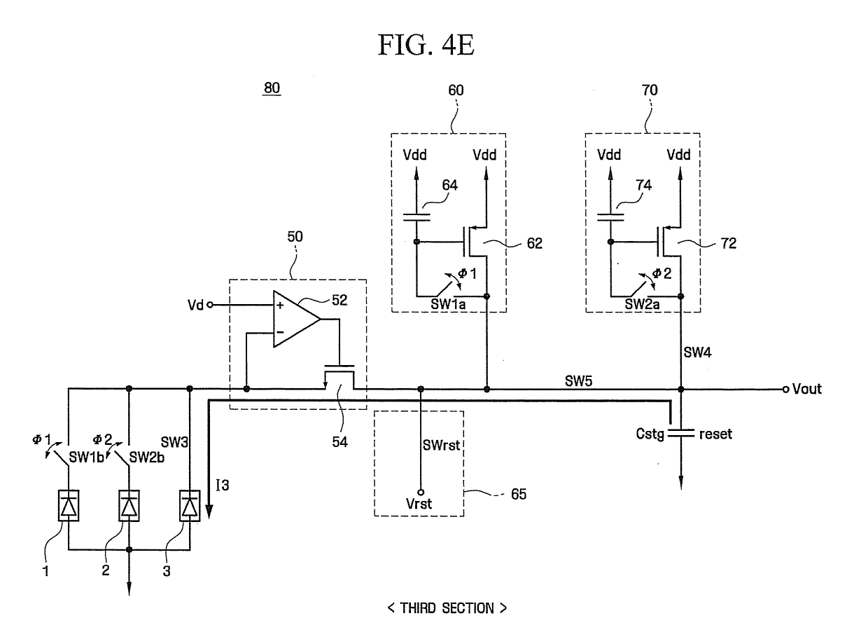

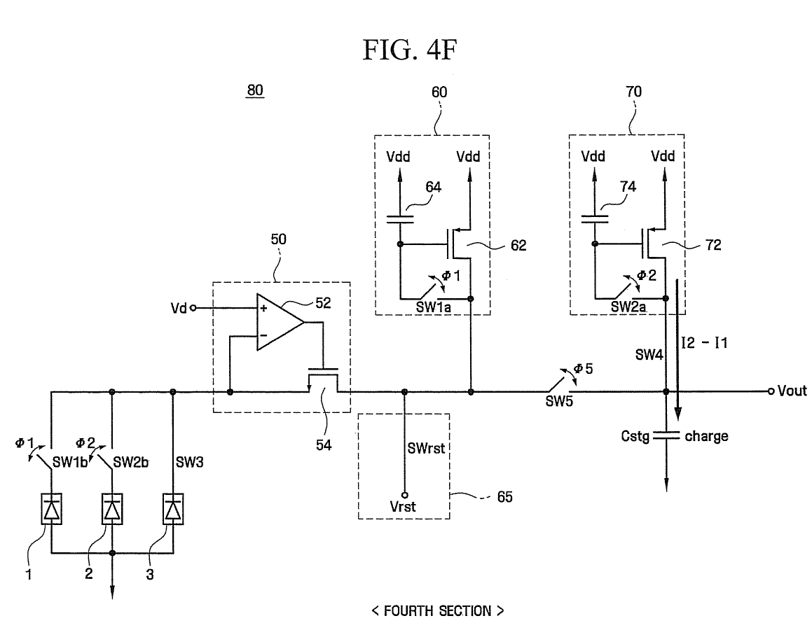

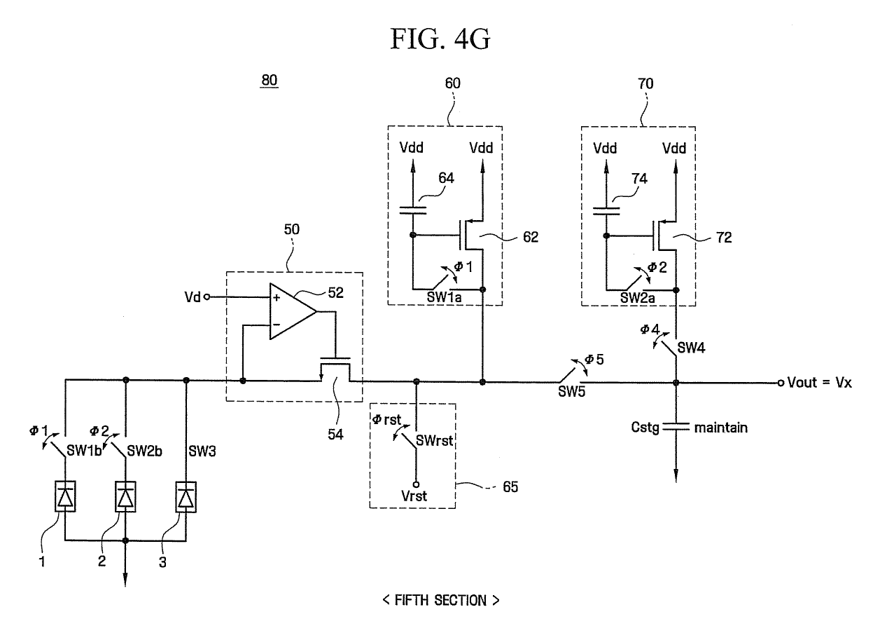

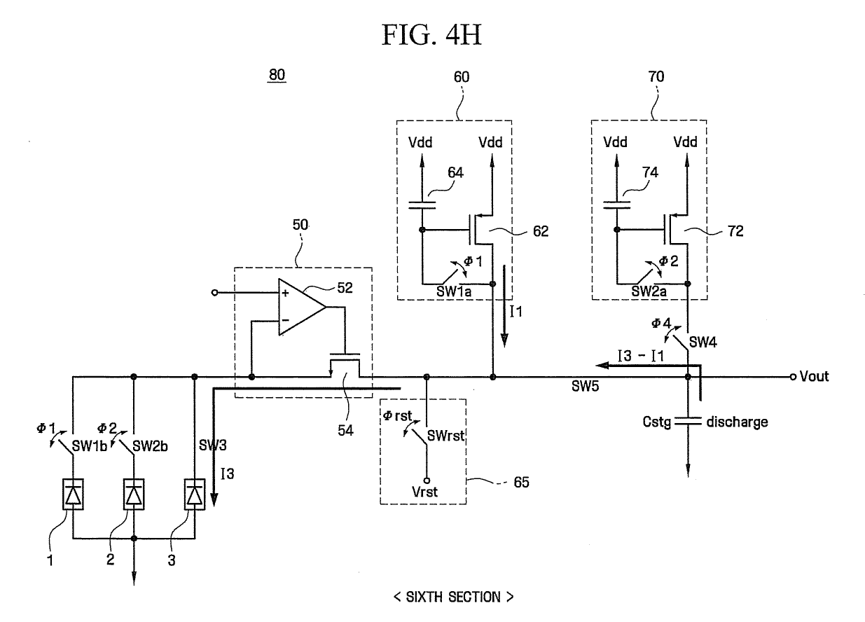

As will be described in further detail below with reference to FIGS. 3 through 4H, the first photosensor 1 outputs a first reference current I1 corresponding to a first reference light, the second photosensor 2 outputs a second reference current I2 corresponding to a second reference light, and the third photosensor 3 outputs an external light current I3 corresponding to an external light. In an exemplary embodiment, an intensity of each of the first reference light and the second reference light is preset to a predetermined value. For example, the intensity of the first reference light may be preset for a light level in a dark room, and the intensity of the second reference light may be preset for a backlight intensity, but alternative exemplary embodiments are not limited thereto. While the intensities of the first reference light and the second reference light are preset, an intensity of the external light varies and is measured by the photosensor circuit 95.

Still referring to FIG. 2, the read-out circuit 80 further includes a first current memory 60 and a second current memory 70. In an exemplary embodiment, the first current memory 60 and the second current memory 70 include a metal oxide semiconductor (“MOS”) transistor 62 and 72, respectively, a memory capacitor 64 and 74, respectively, connected between a supply voltage Vdd and gate of the MOS transistor 62 or 72, respectively, and a switch SW1a and SW2a, respectively, connected between a gate electrode and a drain electrode of the MOS transistor 62 and 72, respectively, as shown in FIG. 2.

The first current memory 60 and the second current memory 70 are circuits which sense an input current, reproduce the sensed input current and output the sensed input current. More specifically, the first current memory 60 senses and reproduces the first reference current I1 output from the first photosensor 1, and the second current memory 70 senses and reproduces a difference between the second reference current I2 output from the second photosensor 2 and the first reference current I1 output from the first photosensor 1. Operation of the first current memory 60 and the second current memory 70 will be described in further detail below.

The storage capacitor Cstg charges based upon the difference between the second reference current 12 and the first reference current I1. Specifically, a current based on the difference between the second reference current I2 and the first reference current I1, which is reproduced and outputted by the second current memory 70, as described above, flows into the storage capacitor Cstg during a first period of time T1 (FIG. 3). Subsequently, the storage capacitor Cstg discharges by a difference between the external light current I3 output from the third photosensor 3 and the first reference current I1 reproduced by the first current memory 60, e.g., a current based on the difference between the external light current I3 and the first reference current I1 flows out of the storage capacitor Cstg during a second period of time T2 (FIG. 3).

The read-out circuit 80 may further include a buffered direct injection circuit 50 which applies a bias voltage Vd to the first photosensor 1, the second photosensor 2 or the third photosensor 3. More specifically, the buffered direct injection circuit 50 includes an operational amplifier 52 and a MOS transistor 54. The bias voltage Vd is applied to a non-inverting input terminal of the operational amplifier 52. An inverting input terminal of the operational amplifier 52 is connected to the first photosensor 1, the second photosensor 2 or the third photosensor 3 via a switch SW1b, SW2b or SW3, respectively, and a source of the MOS transistor 54, as shown in FIG. 2. In addition, an output terminal of the operational amplifier 52 is connected to a gate of the MOS transistor 54.

The buffered direct injection circuit 50 applies the bias voltage Vd to the first photosensor 1, the second photosensor 2 or the third photosensor 3 of the read-out circuit 80. Since the operational amplifier 52 and the MOS transistor 54 are electrically connected to each other in a negative feedback manner, as described above, the buffered direct injection circuit 50 stably applies the bias voltage Vd to the first photosensor 1, the second photosensor 2 or the third photosensor 3.

The read-out circuit 80 may further include a reset voltage input terminal 65 which inputs a reset voltage Vrst to the read-out circuit 80 via a reset switch SWrst, as described in further detail below.

Operation of the read-out circuit 80 will now be described in further detail with reference to FIGS. 3 through 4H. FIG. 3 is a signal timing diagram of the read-out circuit 80 of the photosensor circuit according to the exemplary embodiment of the present invention shown in FIG. 2 and a corresponding graph of voltage versus time illustrating a variation of a voltage in a storage capacitor of the read-out circuit 80 of the photosensor circuit according to the exemplary embodiment of the present invention shown in FIG. 2. FIGS. 4A through 4H are schematic circuit diagrams illustrating different operations of the read-out circuit 80 according to the exemplary embodiment of the present invention shown in FIG. 2. More specifically, FIGS. 4A through 4H sequentially illustrate an operation of the of the read-out circuit 80 in which the operation is divided into: a first section having a first part and a second part thereof, a second section having a first part and a second part thereof, a third section; a fourth section; a fifth section; and a sixth section, as illustrated in FIG. 3. Thus, in an exemplary embodiment, the read-out circuit 80 is driven base on the abovementioned operation corresponding to the signal timing diagram shown in FIG. 3, but alternative exemplary embodiments are not limited thereto.

Referring to FIGS. 3 and 4A, in the first part of the first section, the first reference current I1 is sensed. Specifically, the switch SW1a of the first current memory 60 and the switch SW1b connected to the first photosensor 1 are closed, and the first photosensor 1 thereby outputs the first reference current I1 corresponding to the first reference light. Then, the first current memory 60 senses the first reference current I1 output from the first photosensor 1. As a result, a current flowing through a drain of the MOS transistor 62 of the first current memory 60 changes, which in turn changes a voltage at the gate of the MOS transistor 62. The changed voltage at the gate of the MOS transistor 62 is applied to the memory capacitor 64 of the first current memory 60.

Referring to FIGS. 3 and 4B, in the second part of the first section, the first reference current I1 is reproduced by the first current memory 60 when the switches SW1a and SW1b open, the first current memory 60 reproduces the first reference current I1 sensed during the first part of the first section. More specifically, when the switch SW1a of the first current memory 60 opens, the voltage at the memory capacitor 64 is maintained. As a result, the voltage at the memory capacitor 64 corresponds to the first reference current I1 sensed by the MOS transistor 62 during the first part of the first section. Therefore, since the voltage of the memory capacitor 64 is applied to the gate of the MOS transistor 62, the first reference current I1 sensed during the first part of the first section is reproduced at the drain of the MOS transistor 62.

Referring to FIGS. 3 and 4C, in the first part of the second section, a difference (I2−I1) between the first reference current I1 and the second reference current I2 is sensed. Specifically, switches SW2a, SW2b, SW4 and SW5 are closed, and the second photosensor 2 outputs the second reference current I2 corresponding to the second reference light. Since the first current memory 60 is reproducing the first reference current I1, the second current memory 70 senses the difference between the second reference current I2 output from the second photosensor 2 and the first reference current I1 reproduced by the first current memory 60 according to Kirchhoff's current law. The second current memory 70 operates based on substantially the same operating principle as that of the first current memory 60, and thus a repetitive description of the operation of the second current memory 70 will be omitted herein.

Referring to FIGS. 3 and 4D, in the second part of the second section, the difference (I2−I1) between the first reference current I1 and the second reference current I2 is reproduced. Specifically, switches SW2a and SW2b open, while switches SW4 and SW5 remain closed. Thus, the second current memory 70 reproduces the difference between the first reference current I1 and the second reference current I2 which is sensed during the first part of the second section (FIG. 4C). Again, since the second current memory 70 operates based on substantially the same operating principle as that of the first current memory 60, a detailed description of the operation thereof will be omitted herein.

Referring to FIGS. 3 and 4E, in the third section, the storage capacitor Cstg is reset. Specifically, the switch SW3 and the reset switch SWrst are closed (the switches SW4 and SW5 remain closed) and the reset voltage Vrst is thereby applied to the storage capacitor Cstg by the reset voltage input terminal 65 via the closed reset switch SWrst. Thus, a accumulated in the storage capacitor Cstg flows out through a closed loop formed when the switch SW3 is closed, and a voltage of the storage capacitor Cstg is thereby reset to the reset voltage Vrst.

Referring to FIGS. 3 and 4F, in the fourth section, the storage capacitor Cstg is charged up to a voltage Vx. Specifically, the switches SW3, SW4 and SWrst remain closed while the switch SW5 is opened, and the difference between the first reference current I1 and the second reference current I2, which is reproduced by the second current memory 70, flows into the storage capacitor Cstg. As a result, the storage capacitor Cstg is charged up to the voltage Vx during the first period of time T1 (FIG. 3).

Referring to FIGS. 3 and 4G, in the fifth section, the voltage of the storage capacitor Cstg is maintained at substantially the voltage Vx. Specifically, the switch SW3 remains closed while the reset switch SWrst and the switch SW5 are opened. Therefore, no current flows into or out of the storage capacitor Cstg, since the switches SW4 and SW5 are open, and the voltage of the storage capacitor Cstg is thereby maintained substantially at the voltage Vx.

Referring to FIGS. 3 and 4H, in the sixth section, the storage capacitor Cstg is discharged to the reset voltage Vrst. Specifically, the switch SW5 is closed while the switch SW3 remains closed, and electric charges accumulated in the storage capacitor Cstg flow out of the storage capacitor Cstg through a closed loop formed due to the switches SW3 and SW5 being closed. The difference (I3−I1) between the external light current I3 output from the third photosensor 3 and the first reference current I1 reproduced by the first current memory 60 thereby flows out of the storage capacitor Cstg, and the storage capacitor Cstg is discharged. A voltage at the storage capacitor Cstg drops to some value via the reset voltage Vrst. A second period of time T2 (FIG. 3) is the time when the voltage at the storage capacitor Cstg becomes the reset voltage Vrst.

Hereinafter, a process of measuring an intensity of external light using the read-out circuit 80 described in greater detail above will be mathematically described in further detail.

In general, an external light current Ipd(X) based on an intensity of an external light X may be defined by Equation (1) below.

Ipd(X)=mX+n (1)

where an inclination m and an offset n each has a different value for each liquid crystal panel.

In Equation (1), if intensities of a first reference light and a second reference light are indicated by reference characters A and B, respectively, and a first reference current and a second reference current, respectively, corresponding to the first reference light and the second reference light, respectively, and indicated by Ipd(A) and Ipd(B), respectively, the inclination m and the offset n can be obtained using Equations (2) and (3) below.

m=(Ipd(B)−Ipd(A))/(B−A) (2)

n=Ipd(A) (3)

In Equations (2) and (3), it is assumed that the first reference current is based on a dark light current and that the intensity of the first reference light is zero.

As will now be described in further detail with respect to FIG. 3, the following equations may be derived from the graph of FIG. 3 showing a variation in a storage capacitor Cstg voltage Vout according to the signal timing diagram thereof and described in further detail above with respect to operation of the of the read-out circuit 80 according to an exemplary embodiment of the present invention.

Referring to FIG. 3, the storage capacitor Cstg is charged for the first period of time T1 until its voltage is increased from the reset voltage Vrst to the voltage Vx. Then, the storage capacitor Cstg is discharged for the second period of time T2 until its voltage is reduced from the voltage Vx to the reset voltage Vrst. Hence, a magnitude of change in voltage of the storage capacitor Cstg for the first period of time T1 is substantially equal to a magnitude of change in voltage of the storage capacitor Cstg for the second period of time T2, as shown in FIG. 3. Put another way, an amount of electric charges flowing into, e.g., charged into, the storage capacitor Cstg for the first period of time T1 is substantially equal to that of an amount of electric charges flowing out of, e.g., discharged from, the storage capacitor Cstg for the second period of time T2, as defined by Equation (4) below.

[Ipd(B)−Ipd(A)]*T1=[Ipd(X)−Ipd(A)]*T2 (4)

When Equations (1) through (3) are substituted into Equation (4), Equation (5) below is obtained.

T2=T1*(B−A)/X (5)

where values of the intensity of the first reference light A and the intensity of the second reference light B and a value of the first period of time T1 are preset. Therefore, if a duration of the second period of time T2 is measured, the intensity of the external light X can be calculated. When the intensity of the external light X of the external light is calculated using Equation (5), the inclination m and the offset n are automatically reflected, wherein the inclination m and the offset n are characteristic values of each individual liquid crystal panel manufactured and have different values for each liquid crystal panel manufactured.

Since the read-out circuit 80 included in the photosensor circuit 95 which measures an intensity of an external light is an analog-type circuit, it can be simply designed and easily implemented on a panel of the LCD 5 according to an exemplary embodiment of the present invention. In addition, since the intensity of the external light is measured in real time, there is no need to store additional data, as is required to correct a photosensor according to an LCD of the prior art.

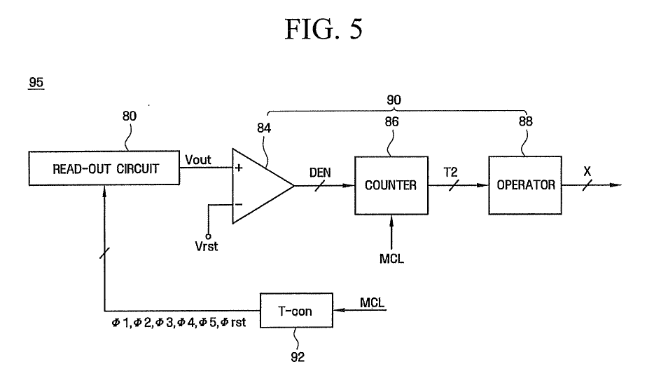

Hereinafter, a photosensor circuit 95 including a read-out circuit 80 substantially similar to the read-out circuit 80 described above will be described in further detail with reference to FIGS. 2, 3 and 5. FIG. 5 is a block diagram of a photosensor circuit according to an alternative exemplary embodiment of the present invention.

Referring to FIGS. 3 and 5, a photosensor circuit 95 according to an alternative exemplary embodiment includes a read-out circuit 80 and a determiner 90. A timing controller (“T-con”) 92 receives a main clock signal 92 from an outside source (not shown) and supplies a plurality of T-con signals to the read-out circuit 80. The plurality of T-con includes a first T-con signal Φ1, a second T-con signal Φ2, a third T-con signal Φ3, a fourth T-con signal Φ4, a fifth T-con signal Φ5 and a reset T-con signal Φrst. The plurality of T-con signals controls an operation of the read-out circuit 80 which thereafter outputs a storage capacitor voltage Vout.

The determiner 90 includes a comparator 84, a counter 86 and an operator 88. Specifically, the determiner 80 calculates, e.g., determines, an intensity of an external light X based on intensities of a first reference light and a second reference light during a first period of time T1 and a second period of time T2, as described above in greater detail with reference to FIGS. 3 and 4A through 4H.

More specifically with reference to FIG. 5, the comparator 84 compares a reset voltage Vrst to the storage capacitor voltage Vout output from the read-out circuit 80 and provides a disable signal DEN to the counter 86 when the storage capacitor voltage Vout is substantially equal to the reset voltage Vrst.

The counter 86 is enabled when the storage capacitor voltage Vout begins to discharge, e.g., in the fifth section (FIG. 3), and thereby measures a duration of the second period of time T2 from when the counter 86 is enabled to when the counter 86 receives the disable signal DEN from the comparator 84.

The operator 88 receives the measured duration of the second period of time T2 from the counter 86, multiplies a difference between the preset, e.g., predetermined, intensities of the first reference light and the second reference light, by a preset, e.g., predetermined duration of the first period of time T1, and divides the result of the multiplied difference by the duration of the measured second period of time T2, thereby calculating the intensity of the external light X.

The calculated intensity of the external light X is then provided to a backlight luminance control device (not shown), and the backlight luminance control device controls a luminance of backlight from a backlight unit (FIG. 1A) based on the calculated intensity of the external light X.

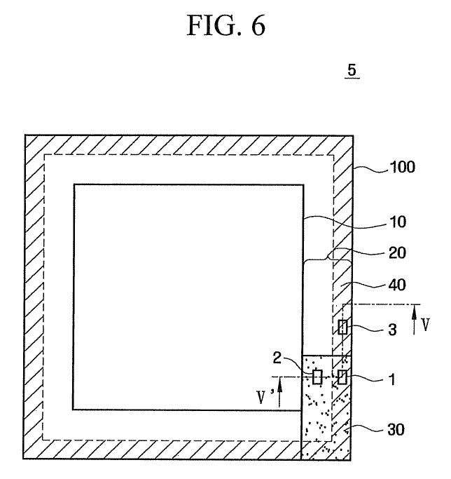

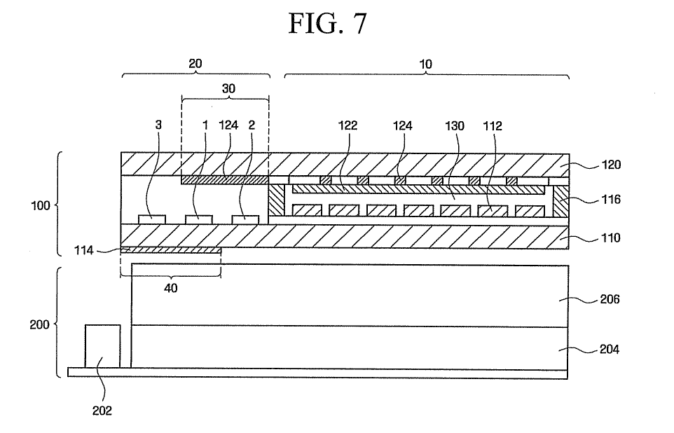

Hereinafter, an LCD according to an exemplary embodiment of the present invention will be described with reference to FIGS. 6 and 7. FIG. 6 is a plan view of an LCD according to an exemplary embodiment of the present invention. FIG. 7 is a partial cross-sectional view taken along line V-V′ of the LCD according to the exemplary embodiment of the present invention shown in FIG. 6.

Referring to FIGS. 6 and 7, an LCD 5 according to an exemplary embodiment includes a liquid crystal panel 100, a photosensor circuit 95 (FIGS. 1A and 1B) and a backlight unit 200.

The liquid crystal panel 100 includes a first substrate 110 having a plurality of pixel electrodes 112 disposed thereon, a second substrate 120 having a common electrode 122, and a liquid crystal layer 130 injected between the first substrate 110 and the second substrate 120.

The backlight unit 200 supplies backlight to the liquid crystal panel 100 and includes a light source 202, a light guide plate 204, and an optical sheet 206.

The light source 202 may be a plurality of light-emitting diodes and emit light to the light guide plate 204. The light output from the light- source 202 is input to an incident surface of the light guide plate 204, and the other surfaces of the light guide plate 204 reflect and thus diffuse the light in all directions, ultimately, to the optical sheet 206.

The optical sheet 206 includes a diffusion sheet and a prism sheet. The optical sheet 206 diffuses the light from the light guide plate 204 to a bottom surface of the liquid crystal panel 100.

In an exemplary embodiment, the first substrate 110 includes a first light-blocking region 40 which blocks backlight. The first light-blocking region 40 may be formed, for example, as a backlight unit tape 114, but is not limited thereto. The backlight unit tape 114 attaches the liquid crystal panel 100 to the backlight unit 200 and blocks backlight from reaching the liquid crystal panel 100.

The second substrate 120 also includes a second light-blocking region 30 which blocks external light. The second light-blocking region 340 may include a black matrix 124, for example, but is not limited thereto. The black matrix 124 prevents light from transmitting through or between pixels and increases a contrast ratio of the LCD 5.

In an alternative exemplary embodiment, the backlight unit tape 114 which attaches the first substrate 110 and the second substrate 120 to each other maybe formed substantially the same as a seal member 116, described in further detail below.

The liquid crystal panel 100 may be divided into a display region 10 and a non-display region 20. The display region 10 corresponds to an area wherein the pixel electrodes 112 are disposed and an image is thereby displayed. The display region 10 includes a plurality of gate lines (not shown) arranged in a first direction, a plurality of data lines (not shown) arranged in a second direction substantially perpendicular to the first direction and a plurality of pixels (not shown) disposed substantially at intersections of gate lines and data lines of the plurality of gate lines and the plurality of data lines, respectively.

The non-display region 20 is disposed on a peripheral area of the display region 10, e.g., substantially surrounds the display region 10, as shown in FIG. 6. An image is not displayed in the non-display region 20. The non-display region 20 may include the first light-blocking region 40 and the second light-blocking region 30.

The first light-blocking region 40 may be formed, for example, by disposing the backlight unit tape 114 between the liquid crystal panel 100 and the backlight unit 200. The second light-blocking region 30 may be formed, for example, as the black matrix 124 and/or the seal member 116.

As described above, the first light-blocking region 40 blocks backlight, and the second light-blocking region 30 blocks external light. Thus, a region in which the first and second light-blocking regions 30 and 40 overlap each other blocks both the backlight and the external light.

In an exemplary embodiment, the first photosensor 1, the second photosensor 2 and the third photosensor 3 of the photosensor circuit 95 (FIG. 1A) are disposed in the non-display region 20. Specifically, the first photosensor 1 is disposed in a region in which the first light-blocking regions 40 and the second light-blocking region 30 overlap, and the second photosensor 2 is disposed only in the second light-blocking region 30. In this case, the first photosensors 1 and the second photosensor 2 receive a dark light and a relatively bright light, respectively. The dark light and the bright light may be referred to as a first reference light and a second reference light, as described above. The third photosensor 3 is disposed in the first light-blocking region 40, and is thereby exposed to an external light while remaining unexposed to backlight of the LCD 5, and thus outputs an external light current.

In an alternative exemplary embodiment, the second photosensor 2 receives a relatively bright light from an additional light source (not shown) instead of the light source 202. When the additional light source is used, light other than backlight is therefore referred to as a second reference light. In this case, the first photosensor 1 and the third photosensor 3 must be shielded from the additional light source.

In the LCD 5 according to an exemplary embodiment the first photosensor 1, the second photosensor 2 and the third photosensor 3 are pin photodiodes, but alternative exemplary embodiments are not limited thereto. The pin photodiodes may be implemented in a polysilicon thin film transistor (“TFT”) process. In this case, the pin photodiodes can be simply implemented into the read-out circuit 80.

The first photosensor 1, the second photosensor 2 and the third photosensor 3 may be implemented adjacent to each other on the first substrate 10 of the liquid crystal panel 100. Therefore, variations in variables which affect optical characteristics of the first photosensor 1, the second photosensor 2 and the third photosensor 3 are substantially reduced. Thus, errors caused by the variables are effectively reduced. The variables may include, for example, non-uniform optical characteristics of the liquid crystal panel 100, temperature changes due to the generation of backlight and a brightness variation of the backlight unit 200, but are not limited thereto.

Thus, in the LCD 5 according to exemplary embodiments of the present invention as described herein, a luminance of backlight of a backlight unit 200 is controlled according to an intensity of an external light which is calculated by a photosensor circuit 95. Since the photosensor circuit 95 accurately calculates the intensity of the external light in real time, a luminance of the backlight can be properly controlled.

The present invention should not be construed as being limited to the exemplary embodiments set forth herein. Rather, these exemplary embodiments are provided so that this disclosure will be thorough and complete and will fully convey the concept of the present invention to those skilled in the art.

The exemplary embodiments described herein should be considered in a descriptive sense only and not for purposes of limitation. Therefore, while the present invention has been particularly shown and described with reference to exemplary embodiments thereof, it will be understood by those of ordinary skill in the art that various changes in form and details may be made therein without departing from the spirit or scope of the present invention as defined by the following claims.

What is claimed is:

1. A photosensor circuit comprising:
a read-out circuit comprising:
a first photosensor which outputs a first reference current corresponding to an intensity of a first reference light;
a second photosensor which outputs a second reference current corresponding to an intensity of a second reference light;
a third photosensor which outputs an external light current corresponding to an intensity of an external light;
a first current memory which senses and reproduces the first reference current;
a second current memory which senses and reproduces a difference between the second reference current and the first reference current; and
a storage capacitor which charges during a first period of time based on the difference between the second reference current and the first reference current, and which discharges during a second period of time based on a difference between the external light current and the first reference current; and
a determiner which calculates the intensity of the external light based on the intensity of the first reference light, the intensity of the second reference light, a duration of the first period of time and a duration of the second period of time.

2. The photosensor circuit of claim 1, wherein
an operation of the read-out circuit is temporally divided into a plurality of sections, the plurality of sections comprising:
a first section having a first part and a second part;
a second section having a first part and a second part;
a third section; and
a fourth section,
the first photosensor outputs the first reference current and the first current memory senses the first reference current in the first part of the first section,
the first current memory reproduces the sensed first reference current in the second part of the first section,
the second photosensor outputs the second reference current and the second current memory senses the difference between the first reference current and the second reference current in the first part of the second section,
the second current memory reproduces the sensed difference between the first reference current and the second reference current in the second part of the second section,
the storage capacitor charges during the first period of time, based on the reproduced sensed difference between the first reference current and the second reference current, in the third section, and
the storage capacitor discharges during the second time period, based on the difference between the external light current and the first reference current, in a fourth section.

3. The photosensor circuit of claim 2, wherein
a reset voltage is applied to the storage capacitor between the second part of the second section and the third section, and
the storage capacitor discharges to a voltage level substantially equal to the reset voltage during the second period of time in the fourth section.

4. The photosensor circuit of claim 1, wherein the read-out circuit further comprises a buffered direct injection circuit which applies a bias voltage to at least one of the first photosensor, the second photosensor and the third photosensor.

5. The photosensor circuit of claim 1, wherein the first current memory and the second current memory comprise:
a metal oxide semiconductor transistor;
a memory capacitor connected to a gate of the metal oxide semiconductor transistor; and
a switch connected between the gate of the metal oxide semiconductor transistor and a drain of the metal oxide semiconductor transistor.

6. The photosensor circuit of claim 3, wherein the determiner comprises:
a comparator which compares the reset voltage to a voltage level of the storage capacitor and generates a disable signal when the voltage level of the storage capacitor is substantially equal to the reset voltage;
a counter which measures a duration of the second period of time based on an elapsed time between when the storage capacitor begins to discharge and when the comparator generates the disable signal; and
an operator which calculates the intensity of the external light using a predetermined intensity of the first reference light, a predetermined intensity of the second reference light, a predetermined duration of the first period of time and the measured duration of the second period of time.

7. The photosensor circuit of claim 6, wherein the operator calculates the intensity of the external light by multiplying a difference between the predetermined intensity of the first reference light and the predetermined intensity of second reference light by the predetermined duration of the first period of time and divides the multiplied difference by the duration of the second period of time measured by the counter.

8. A liquid crystal display comprising:
a liquid crystal panel which displays an image;
a photosensor circuit which measures an intensity of external light and comprises a read-out circuit and a determiner; and
a backlight unit which provides backlight to the liquid crystal panel, wherein the read-out circuit comprises:
a first photosensor which outputs a first reference current corresponding to an intensity of a first reference light;
a second photosensor which outputs a second reference current corresponding to an intensity of a second reference light;
a third photosensor which outputs an external light current corresponding to the intensity of the external light;
a first current memory which senses and reproduces the first reference current;
a second current memory which senses and reproduces a difference between the second reference current and the first reference current; and
a storage capacitor which charges during a first period of time based on the difference between the second reference current and the first reference current, and which discharges during a second period of time based on a difference between the external light current and the first reference current,
the determiner calculates the intensity of the external light based on the intensity of the first reference light, the intensity of the second reference light, a duration of the first period of time and a duration of the second period of time, and
a luminance of the backlight is controlled according to the calculated intensity of the external light.

9. The liquid crystal display of claim 8, wherein the external light and the backlight are blocked from the first photosensor, the backlight is provided to the second photosensor, and the external light is provided to the third photosensor.

10. The liquid crystal display of claim 8, wherein
the liquid crystal panel comprises a display region and a non-display region,
the non-display region comprises a first light-blocking region which blocks the backlight and a second light-blocking region which blocks the external light,
the first light-blocking region blocks the external light from reaching the first photosensor and the second photosensor, and
the second light-blocking region blocks the backlight from reaching the first photosensor and the third photosensor.

11. The liquid crystal display of claim 10, wherein the first light-blocking region is a backlight unit tape attached to the liquid crystal panel and the backlight.

12. The liquid crystal display of claim 10, wherein the second light-blocking region is a black matrix.

13. The liquid crystal display of claim 8, wherein at least one of the first photosensor, the second photosensor and the third photosensor comprise a pin photodiode.

14. The liquid crystal display of claim 8, wherein at least two of the first photosensor, the second photosensor and the third photosensor are disposed adjacent to each other in the liquid crystal panel.

15. The liquid crystal display of claim 8, wherein
an operation of the read-out circuit is temporally divided into a plurality of sections, the plurality of sections comprising:
a first section having a first part and a second part;
a second section having a first part and a second part;
a third section; and
a fourth section,
the first photosensor outputs the first reference current and the first current memory senses the first reference current in the first part of the first section,
the first current memory reproduces the sensed first reference current in the second part of the first section,
the second photosensor outputs the second reference current and the second current memory senses the difference between the first reference current and the second reference current in the first part of the second section,
the second current memory reproduces the sensed difference between the first reference current and the second reference current in the second part of the second section,
the storage capacitor charges during the first period of time, based on the reproduced sensed difference between the first reference current and the second reference current, in the third section, and
the storage capacitor discharges during the second time period, based on the difference between the external light current and the first reference current, in a fourth section.

16. The liquid crystal display of claim 15, wherein
a reset voltage is applied to the storage capacitor between the second part of the second section and the third section, and
the storage capacitor discharges to a voltage level substantially equal to the reset voltage during the second period of time in the fourth section.

17. The liquid crystal display of claim 8, wherein the read-out circuit further comprises a buffered direct injection circuit which applies a bias voltage to at least one of the first photosensor, the second photosensor and the third photosensor.

18. The liquid crystal display of claim 8, wherein the determiner comprises:
a comparator which compares the reset voltage to a voltage level of the storage capacitor and generates a disable signal when the voltage level of the storage capacitor is substantially equal to the reset voltage;
a counter which measures a duration of the second period of time based on an elapsed time between when the storage capacitor begins to discharge and when the comparator generates the disable signal; and
an operator which calculates the intensity of the external light using a predetermined intensity of the first reference light, a predetermined intensity of the second reference light, a predetermined duration of the first period of time and the measured duration of the second period of time.

19. A method of driving a liquid crystal display, the method comprising:
generating a first reference current, corresponding to an intensity of a first reference light, and sensing the first reference current in a first part of a first section of an operation;
reproducing the sensed first reference current in a second part of the first section of the operation;
outputting the second reference current and sensing a difference between the first reference current and the second reference current in a first part of a second section of the operation;
reproducing the sensed difference between the first reference current and the second reference current in a second part of the second section of the operation;
receiving the reproduced sensed difference between the first reference current and the second reference current for a first period of time in a third section of the operation;
outputting a difference between an external light current corresponding to an intensity of an external light and the first reference current for a second period of time in a fourth section of the operation;
calculating the intensity of the external light using the intensity of the first reference light, the intensity of the second reference light, a duration of the first period of time and a duration of the second period of time;
controlling a luminance of backlight according to the calculated intensity of the external light;
receiving the backlight having the controlled luminance; and
displaying a desired image with the backlight.

20. The method of claim 19, wherein the calculating of the intensity of the external light comprises:
measuring the duration of the second period of time;
multiplying a difference between the intensity of the first reference light and the second reference light by the duration of the first period of time; and
dividing the multiplied difference by the duration of the second period of time.
